(19) United States
(12) Patent Application Publication
(10) Pub. No.: US 2025/0136161 A1
(43) Pub. Date: May 1, 2025

(54) CART FOR PHOTOGRAPHING

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 18/753,261

(22) Filed: Jun. 25, 2024

(30) Foreign Application Priority Data
Oct. 26, 2023 (CN) 2023228883522

(51) Int. Cl. B62B 3/02

(52) U.S. Cl. CPC B62B 3/02

(57) ABSTRACT

The present application pertains to the technical domain of photography equipment, specifically addressing a cart for photographing. This cart for photographing comprises a cart frame and a storage platform. The cart frame incorporates a plurality of support members, and the storage platform is affixed to these support members. The storage platform consists of a base plate and upright plates. These upright plates are arranged continuously around the base plate, enclosing storage slots designed for supporting photography accessories. Each of these upright plates is equipped with a plurality of connection interfaces of varying specifications, facilitating the installation of photography accessories. This configuration effectively augments the storage capacity of the cart for photographing. Photography accessories can be installed on the cart for photographing via these connection interfaces, allowing them to be suspended outside or above the cart.

### CROSS-REFERENCE TO RELATED APPLICATIONS

The present application for patent claims priority to and the benefit of pending Chinese Application No. 2023228883522, filed Oct. 26, 2023, and hereby expressly incorporated by reference herein as if fully set forth below in its entirety and for all applicable purposes.

### TECHNICAL FIELD

This application pertains to the technical field of photography equipment, specifically addressing a cart for photographing.

### INTRODUCTION

A cart for photographing is a trolley used in film and television shooting scenes to hold photography props, primarily assisting personnel in their shooting tasks.

Currently available cart for photographing typically includes a cart frame with two shelves for placing photography props or equipment. The bottom of the cart frame is equipped with a plurality of casters or wheels for mobility, and handles are installed on the cart frame for easy pushing by personnel. However, due to the size limitations of the supporting shelves, the storage space of the cart for photographing is limited.

### BRIEF SUMMARY

Aspects of this application provides a cart for photographing to address the issue of limited storage space.

According to one aspect of this application, an embodiment of a cart for photographing is provided, comprising:

A cart frame featuring a plurality of support members;

A storage platform connected to the support members, consisting of a base plate and upright plates. The upright plates, arranged continuously around the base plate, enclose storage slots designed for supporting photography accessories. Each upright plate is equipped with a plurality of connection interfaces of varying specifications for installing photography accessories.

Furthermore, the cart further comprising an expansion component, the expansion component connected to at least one of the plurality of support members; the expansion component is furnished with a plurality of expansion interfaces of different specifications for installing the photography accessory.

Furthermore, wherein the connection interfaces encompass one or more of a threaded interface, a gear interface, a groove, a slider, and a duct interface; the expansion interfaces comprise one or more of a threaded interface, a gear interface, a groove, a slider, and a duct interface.

Furthermore, wherein the expansion component comprises an expansion connecting piece and an expansion platform; the expansion platform being mounted on at least one of the plurality of support members by the expansion connecting piece, and the expansion platform comprises a expansion slot for supporting the photography accessory.

Furthermore, wherein both the expansion connecting pieces and the expansion platforms are equipped with the expansion interfaces

Furthermore, wherein the upright plate being connected to the base plate, and a locking structure secures the upright plate to the base plate; the locking structure comprises a locking pin provided on one of the upright plate and the base plate and a locking hook or loop provided on the other. the locking structure operates in a locked state and an unlocked state; in the locked state, the locking pin engages with the locking hook or loop, maintaining the upright plate perpendicular to the base plate; in the unlocked state, the locking pin disengages from the locking hook or loop, allowing the upright plates to rotate relative to the base plate.

Furthermore, wherein the storage platform comprises a holding structure capable of maintaining the upright plate at the same level as the base plate; or, the upright plate being connected to the base plate via a damping hinge, and the damping hinge being capable of maintaining the upright plate at the same level as the base plate.

Furthermore, wherein the holding structure comprises a tension rope connecting the base plate and the upright plate; or, the holding structure comprises a limit support member installed on the base plate, supporting the upright plate to keep the upright plate aligned with the base plate.

Furthermore, wherein each of the plurality of support members comprises a support pillar, and the storage platform comprises a first storage platform and a second storage platform connected to the support pillar at both ends; a first end of the support pillar is detachably connected to the second storage platform, and a second end is movably assembled within a storage slot of the first storage platform by a support pillar shaft.

Furthermore, wherein a latch being provided on one of the first storage platform or the second storage platform, and a mounting slot being provided on another one that cooperates with the latch.

This cart for photographing comprises a cart frame and a storage platform. The cart frame incorporates a plurality of support members, and the storage platform is affixed to these support members. The storage platform consists of a base plate and upright plates. These upright plates are arranged continuously around the base plate, enclosing storage slots designed for supporting photography accessories. Each of these upright plates is equipped with a plurality of connection interfaces of varying specifications, facilitating the installation of photography accessories. This configuration effectively augments the storage capacity of the cart for photographing. Once the storage slots are occupied, photography accessories can be installed on the cart for photographing via these connection interfaces, allowing them to be suspended outside or above the cart. This optimally utilizes the peripheral space of the cart for photographing, enhancing both its storage capacity and utilization efficiency.

### BRIEF DESCRIPTION OF THE DRAWINGS

FIG. 1: A schematic diagram of an embodiment of the cart for photographing.

FIG. 2: A magnified view of a portion of FIG. 1.

FIG. 3: A schematic diagram of one upright plate tilted and aligned with the base plate in an embodiment.

FIG. 4: A schematic diagram showing the locking structure between the upright plate and the base plate in a connected state in an embodiment.

FIG. 5: A schematic diagram showing one upright plate tilted to align with the base plate, with support members supporting the upright plate in an embodiment.

FIG. 6: A schematic diagram showing all four support pillars tilted into the storage slot in an embodiment.

FIG. 7: A schematic diagram showing either the first or second storage platform equipped with a latch, and the other equipped with a slot for the latch in an embodiment.

FIG. 8: A magnified view of a portion of FIG. 7.

FIG. 9: A schematic diagram showing the cart for photographing in a box-like structure in an embodiment.

FIG. 10: A cross-sectional schematic diagram showing the engagement of the latch and slot in FIG. 8.

FIG. 11: A schematic diagram of an exemplary damping hinge in an embodiment.

In the figures:
100. cart frame; 200. Damping hinge.
1. Storage platform; 2. First storage platform; 3. Second storage platform; 4. Base plate; 5. Upright plates; 6. Connection interfaces; 7. Storage slots; 8. Support members; 81. Support pillar;
10. Expansion components; 11. Expansion connecting pieces; 111. First expansion piece; 1111. First connection hole; 112. Second expansion piece; 12. Expansion platform; 121. Expansion slots; 13. Expansion interfaces; 14. Connection pipe clamps;
20. Holding structure; 21. Tension rope; 22. Hinges; 23. Limit supports; 30. Locking structure; 31. Locking box components; 311. Locking box body; 3111. Notch; 3112. First mounting groove; 3113. Second mounting groove; 312. Locking pin; 3121. Guiding surface; 313. Trigger component; 314. Linkage component; 315. Spring; 32. Locking loop;
40. Mounting brackets; 41. Support pillar shafts; 42. Installation pipe clamps.
51. Latch; 511. Lever part; 512. Lever shaft; 513. Hook part; 5131. Concave part; 514. Hook shaft; 52. Slot; 521. Projection.

### DETAILED DESCRIPTION

In the following detailed implementation, specific aspects of the cart for photographing are explained in conjunction with the accompanying drawings. Similar components in different embodiments are labeled with corresponding identifiers for clarity. While detailed descriptions are provided to enhance understanding, it is understood that certain features may be omitted or substituted by other components, materials, and methods based on design preferences or technical requirements. In certain instances, some operations applicable to this application may be omitted from the specification to prevent overwhelming the central concept with excessive detail. Nevertheless, for technical experts in this field, a comprehensive understanding of these operations can be derived from the provided descriptions and the general technical knowledge within the industry.

Moreover, the characteristics, operations, or features outlined in the specification may be combined in various ways to create diverse embodiments. The operational steps within each embodiment may also be rearranged or modified in a manner deemed appropriate by technical experts in this field. Consequently, the specification and accompanying drawings serve solely to illustrate a specific embodiment and do not constitute a limitation on the necessary composition and/or sequence.

The numbered components in this document, such as “first” or “second”, serve for differentiation purposes only and do not denote any inherent order or technical significance. The terms “connection” or “joint” encompass both direct and indirect connections unless otherwise specified.

The present application introduces a cart for photographing, which serves as a trolley for accommodating photography props and equipment during film and television shoots. Additionally, it can be utilized as a trolley for storing items in non-film and television shooting scenarios.

This cart for photographing disclosed in this application includes a cart frame 100 and a storage platform 1. The cart frame 100 incorporates a plurality of support members 8, and the storage platform 1 is affixed to these support members 8. Storage platform 1 comprises a base plate 4 and an upright plate 5. The upright plate 5 is arranged continuously around the base plate 4, enclosing storage slots 7 designed for supporting photography accessories. Each of these upright plates 5 is equipped with a plurality of connection interfaces 6 of varying specifications, facilitating the installation of photography accessories.

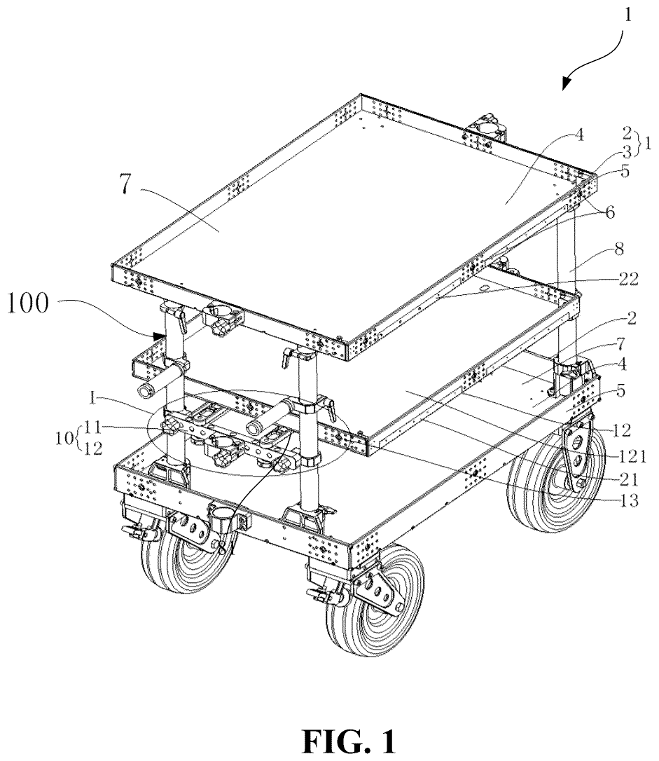

In the disclosed design, the upright plates 5 are equipped with connection interfaces 6 of different specifications, facilitating the installation of diverse photography accessories. This enables the attachment of various photography accessories onto the upright plates 5 through a plurality of connection interfaces 6 once the storage slots 7 are filled, suspending them above or outside the storage slots 7 (e.g., 3 storage slots 7 shown in FIG. 1). This efficient use of space above or outside the cart enhances the cart's storage capacity and utilization efficiency.

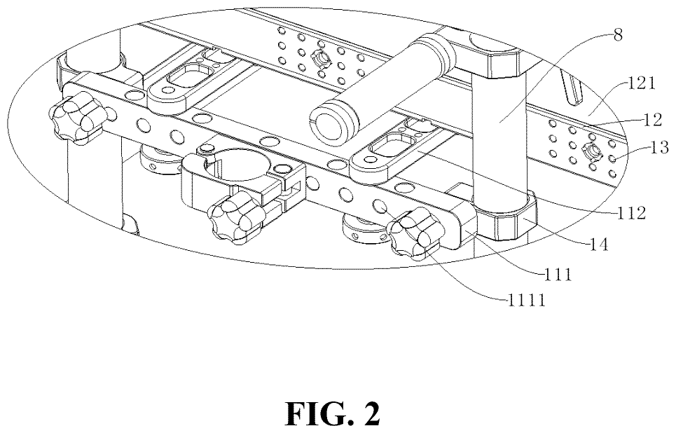

Specifically, referring to FIGS. 1 and 2, the rectangular base plate 4 of the storage platform 1 features support members 8. the support members 8 include a plurality of support pillars 81, Four support pillars 81 are positioned near the four corners of each base plate 4, ensuring stable attachment to the storage platform 1. Surrounding the base plate 4 are four upright plates 5, which are positioned at the four sides of the base plate 4, fixedly connected to it, such as connecting via screws or suitable fasteners, forming the enclosed storage slot 7. These four upright plates 5 are arranged continuously around the base plate 4. The storage slot 7, with its openings facing upward, provides ample space for photography accessories, supported by the upper surface of the base plate 4, which forms the subface of storage slot 7.

Photography accessories encompass a wide range, for example including cameras, tripods, camera cages, monitor brackets, gimbals, and quick-release plates. The connection interfaces 6 can vary in design, for example, accommodating differently sized threaded holes, positioning slots, or slots for secure attachment of accessories. Once the storage slots 7 are filled, additional photography accessories of various types can be installed on the upright plates 5 via differently sized interfaces 6, allowing for suspension above or outside the storage slots 7 or the cart, effectively expanding storage capacity, minimizing bulk, and optimizing utility of the cart.

In some embodiments, the cart further includes expansion components 10 connected to the support members 8. These expansion components 10 are furnished with a plurality of expansion interfaces 13 of different specifications for installing photography accessories.

Continuing with the reference to FIGS. 1 and 2, the expansion components 10 are affixed to the two support pillars 81 located at the longitudinal ends of the base plate 4. These components can be mounted on the support pillars 81 at both ends of the base plate 4. Connection pipe clamps 14 are utilized to secure the expansion components 10 onto the support pillars 81, fastened in place with bolts. These bolts serve a dual purpose: not only do they connect the expansion components 10 to the connection pipe clamps 14, but they also fixedly attach the connection pipe clamps 14 to the support pillars 81. The expansion components 10 typically take the form of elongated block-shaped structures, featuring expansion interfaces 13 along their length. These interfaces 13, available in various specifications, can include threaded holes, positioning slots, or slots of differing sizes. As depicted in FIG. 2, photography accessories can be connected to the expansion components 10 via the connection pipe clamps and expansion interfaces 13. By integrating a plurality of expansion interfaces 13 of various specifications onto the expansion components 10 on the support pillars 81, the number of available interfaces for attaching photography accessories to the cart for photographing is further increased. This expansion augments the storage capacity and enhances the cart's utilization efficiency.

In instances where the storage space of the cart for photographing is constrained, the installation of expansion components 10 may be omitted, relying solely on connection interfaces 6 on the upright plates 5 to provide a larger storage area.

In some embodiments, the connection interfaces 6 encompass threaded interfaces, gear interfaces, grooves, sliders, slots, and duct interfaces (one or several). Similarly, the expansion interfaces 13 can include threaded interfaces, gear interfaces, grooves, sliders, slots, and duct interfaces (one or several).

Specifically, as illustrated in FIGS. 1 and 2, both the connection interfaces 6 on the upright plates 5 and the expansion interfaces 13 on the expansion components 10 can include threaded interfaces and positioning holes of various sizes. For example, threaded interfaces may encompass standard sizes such as ¼-inch and ⅜-inch threaded holes, or other standard or non-standard sizes. Positioning holes may include ⅜-inch holes. Both threaded interfaces and expansion interfaces 13 can connect to the connection pipe clamps 14 for attaching photography accessories.

In alternate embodiments, connection interfaces 6 or expansion interfaces 13 may also be gear interfaces, slots, sliders, or duct interfaces (one or several). Gear interfaces can include gear plates conforming to specifications such as Arri or other industry standards. Slots may adhere to standards like cold shoe or NATO specifications. Sliders are structures compatible with slots, such as cold shoe bases or NATO standard sliders, designed to accommodate various specifications like Arca Swiss (38 mm), Manfrotto (50 mm), or Arri (67 mm) standards. Duct interfaces typically interface with 15 mm or 19 mm ducts and may serve as interfaces on pipe clamps, affixed to the upright plates (5) or expansion components (10) using screws to integrate seamlessly with the overall design. This diverse array of connection interfaces (6) and expansion interfaces (13) in various shapes and sizes can accommodate the installation of commonly used accessories in the film and television industry, rendering the cart for photographing highly adaptable.

In some embodiments, the expansion components 10 include expansion connecting pieces 11 and expansion platforms 12. These expansion platforms 12 are mounted on the support pillars 81 via the expansion connecting pieces 11, featuring expansion slots for supporting photography accessories. Referring to FIG. 1, specifically, the structure of the expansion platform 12 closely resembles that of the storage platform 1. Similarly including a base plate and upright plates, the expansion platform 12 encloses a space to form an expansion slot 121 with a base plate and upright plates. Mounting holes are situated on the base plate of the expansion platform 12, through which bolts are inserted to securely fasten the expansion components 10 for installation of the expansion platform 12 on the support pillars 81.

The storage platform 1 of the cart for photographing can be arranged in pairs, each pair connecting to the ends of the support pillars 81 in the extension direction. By installing the expansion platform 12 between two storage platforms 1 via expansion components 10, the supporting area for placing photography accessories on the cart for photographing is augmented. This extension of the supporting area expands the storage capacity and enhances the utilization efficiency of the cart for photographing.

Of course, if the distance between the two storage platforms 1 is short and there is a need to accommodate photography accessories with greater height on the lower storage platform 1, the expansion platform 12 can be detached from the expansion components 10 to meet specific usage requirements.

In certain embodiments, both the expansion connector 11 and the expansion platform 12 are outfitted with expansion interfaces 13. As depicted in FIGS. 1 and 2, incorporating expansion interfaces 13 of varying size specifications on the upright panels of the expansion connector 11 and the expansion platform 12 further broadens the range and versatility of photography accessories that can be securely installed on the cart for photographing. This enhancement of the storage space ultimately improves its efficiency. However, in cart for photographing without expansion components 10, expansion interfaces 13 may be omitted, or when ample storage space is available with installed expansion components 10, expansion interfaces 13 may not be necessary.

In specific embodiments, as shown in FIG. 2, the expansion connector 11 comprises a first expansion piece 111 and a second expansion piece 112. The second expansion piece 112 is affixed to the expansion platform 12, while the second expansion piece 112 is mounted on the support pillar 81 through the first expansion piece 111 (e.g. the first expansion piece 111, connected to the support pillar 81, and the second expansion piece 112, connected to the first expansion piece 111). The first expansion piece 111 features a plurality of first connection holes 1111 for connecting with the second expansion piece 112, while the second expansion piece 112 has a plurality of second connection holes for linking with the expansion platform 12. Two first expansion pieces 111 may be installed, each connecting between the support pillars 81 at both ends of the base plate 4 in the length direction. Correspondingly, one or more second expansion pieces 112 can be set up for each first expansion piece 111. Both the first expansion piece 111 and the second expansion piece 112 are elongated structures, oriented perpendicular to each other in the length direction. Two second expansion pieces 112 are spaced apart in the width direction of the base plate 4 at one end of the base plate 4 in the length direction, with the other ends of the second expansion pieces 112 connected to the expansion platform 12. This configuration enhances the stability of the connection between the expansion platform 12 and the cart for photographing, mitigating any potential shaking of the expansion platform 12.

A plurality of first connection holes 1111 can be evenly distributed along the length of the first expansion piece 111, while a plurality of second connection holes on the second expansion piece 112 are spaced along its length. By altering the positions of the first connection holes 1111 relative to the second expansion piece 112 and the second connection holes relative to the expansion platform 12, the position of the expansion platform 12 in the horizontal plane can be adjusted. The changes in the connection with different first connection holes 1111 and second connection holes allow a portion of the expansion platform 12 to extend into the space between the two storage platforms 1, effectively elongating the entire cart for photographing to meet the placement requirements of photography accessories with varying height dimensions. Alternatively, by changing the extension direction of the second expansion piece 112 relative to the first expansion piece 111, the entire expansion platform 12 can be shifted out from between the two storage platforms 1 and extended outside the cart for photographing. In this scenario, only one end of the expansion platform 12 in its length direction remains connected to the support pillar 81, catering to the placement requirements of lighter photography accessories. By adjusting the numbers and positions of the first connection holes 1111 and the second connection holes to reposition the expansion platform 12, the versatility of the cart for photographing is further enhanced with requirements for placing various photography accessories met.

In certain embodiments, the upright board 5 can be rotatably connected to the base plate 4, with a locking structure 30 ensuring secure attachment. In one example, this locking structure 30 includes a locking pin 312 positioned on either the upright board 5 or the base plate 4, and a complementary locking hook or loop 32 on the other component. The locking structure 30 functions in two states: locked and unlocked. When locked, the locking pin 312 engages with the locking hook or loop 32, maintaining the upright plate 5 perpendicular to the base plate 4. In the unlocked state, the locking pin 312 disengages from the locking hook or loop 32, allowing the upright plate 5 to rotate or pivot relative to the base plate 4.

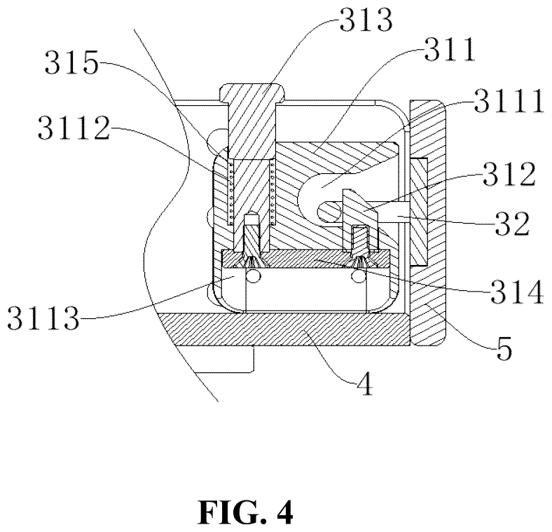

Specifically, in reference to FIGS. 1 to 4, the upright plate 5 connects to the base plate 4 via hinges 22 situated on the base plate's edge. In some aspects, a locking structure 30 is incorporated into the storage platform 1 to firmly affix the upright plate 5 to the base plate 4. This locking structure 30 includes a locking box component 31 mounted on the base plate 4 and a locking hook or loop 32 affixed to the upright plate 5. Illustrated in FIG. 4, the locking box component 31 includes a locking box body 311, a locking pin 312, a trigger component 313, and a linkage component 314. The locking box body 311 features a notch 3111 designed to accommodate the locking hook or loop 32. The opening of the notch 3111 faces the upright plate 5. Additionally, the locking box body 311 includes first and second mounting grooves 3112 and 3113 with openings positioned on the contrary. The trigger component 313 resides within the first mounting groove 3112, with one end extending beyond the groove's edge and the other connected to the linkage component 314 via a screw within the second mounting groove 3113. A spring 315 is installed within the first mounting groove 3112. One end of the spring 315 abuts against the bottom wall of the first mounting groove 3112, while the other end abuts against the trigger component 313. The locking pin 312 traverses the bottom wall of the second mounting groove 3113, with one end residing within the notch 3111 to cooperate with the loop 32 or hook, and the other end remaining within the second mounting groove 3113, securely fastened to the linkage component 314 via a screw.

In the locked state, the upright plate 5 aligns perpendicular to the base plate 4, with the locking hook or loop 32 nestled in the notch 3111 and engaged with the locking pin 312. This configuration restricts the upright plate 5 from rotating relative to the base plate 4. By depressing the terminal of the trigger component 313 longitudinally, it activates the linkage component 314 and the locking pin 312 to move towards the opening of the second mounting groove 3113. This action disengages the locking pin 312 from the locking hook or loop 32, transitioning the locking structure 30 from a locked state to an unlocked state. The fixed connection between the upright plate 5 and the base plate 4 is released. Consequently, the locking hook or loop 32 can be removed from the notch 3111, permitting the upright plate 5 to rotate freely relative to the base plate 4 to be level or underneath it via the hinges 22. This rotation creates working surface on the upper side of the base plate 4, providing an unobstructed workstation for photographers.

Furthermore, in FIGS. 1 to 4, the spring 315 situated inside the first mounting groove 3112 functions to reset the trigger component 313 after the pressure on the trigger component 313 is released. Additionally, the locking pin 312 inserted into the notch 3111 features a guiding surface 3121 (e.g., a ramp) at its end portion. As the upright plate 5 rotates relative to the base plate 4, the locking loop 32 or hook applies pressure against the guiding surface 3121 in the longitudinal direction of the locking pin 312. This action allows the trigger component 313, driven by the locking pin 312 via the linkage component 314, to move towards the opening of the second mounting groove 3113 until the locking loop 32 or hook is in position. Subsequently, the spring 315 aids in resetting the locking pin 312 into engagement with the locking loop 32 or hook, thereby transitioning the locking structure 30 from the unlocked state to the locked state, ensuring a secure connection between the upright plate 5 and the base plate 4.

In some aspects, among the four upright plates 5 surrounding the base plate 4, only those positioned along the length direction of the base plate 4 can rotate relative to the base plate 4 to turn the storage platform into a working platform, thus streamlining the structure of the storage platform.

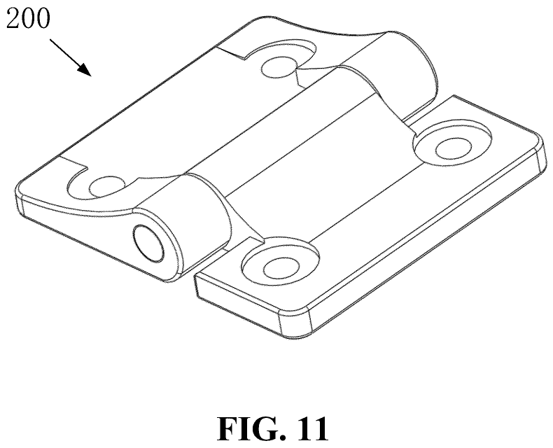

During the rotation of the upright plate 5 relative to the base plate 4, alignment (e.g., horizontal alignment) between the two components can be maintained. In some embodiments, the storage platform 1 incorporates a holding structure 20 to ensure alignment between the upright plate 5 and the base plate 4. Alternatively, the upright plate 5 is connected to the base plate 4 through damping hinges (damping hinge 200 of FIG. 11) or retaining structures, which facilitate alignment between them. This configuration increases the supporting surface area on the storage platform, offering more space for supporting objects on the cart for photographing.

In some aspects, the holding structure 20 may include tension ropes 21 connected between the base plate 4 and adjacent upright plates 5. In some aspects, the holding structure may include limit supports 23 installed on the base plate 4. These limit supports 23 can uphold the upright plate 5 to maintain alignment with the base plate 4.

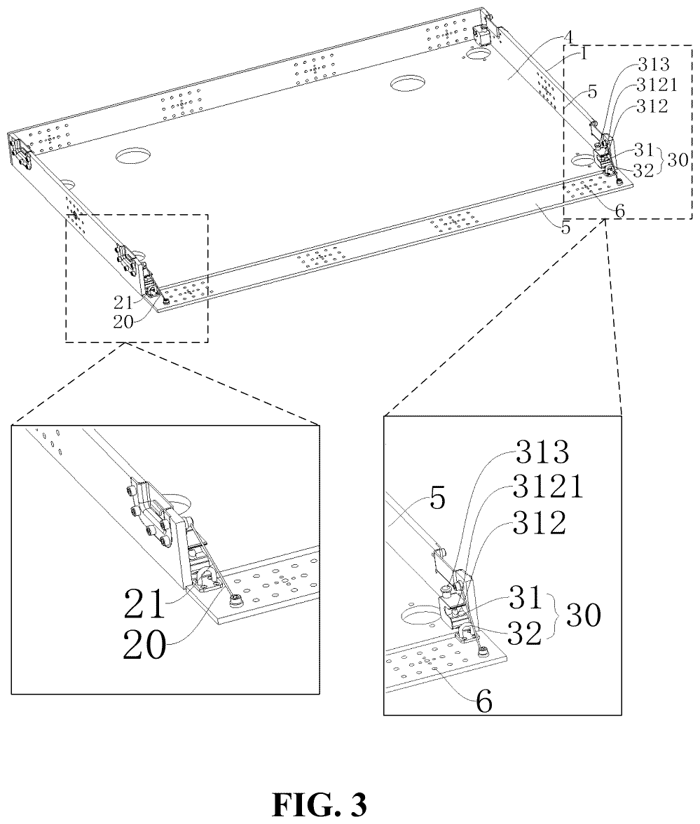

In some aspects, as depicted in FIG. 3, the holding structure 20 includes tension ropes 21 linking adjacent upright plates 5. These tension ropes 21 between two upright plates 5 pull one of the rotatable upright plates 5 to maintain its horizontal position relative to the base plate 4.

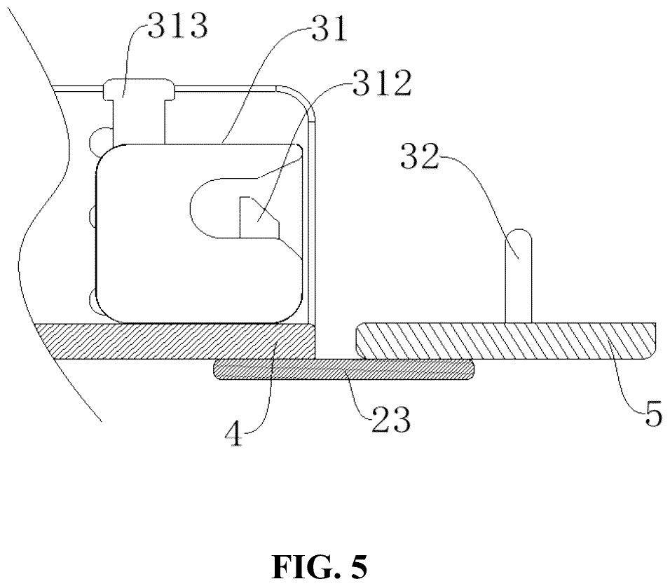

In some aspects, as shown in FIG. 5, in some other embodiments, the holding structure 20 includes limit supports 23 positioned along the edge of the base plate 4 and extending outward from it. These limit supports 23, which can be support plates or pillars welded or connecting with the base plate 4 via bolts, are spaced apart along the length direction of the base plate 4. When the upright plate 5 rotates relative to the base plate 4 to align with it, the limit supports 23 provide support to keep the upright plate 5 aligned with the base plate 4.

In some embodiments, the holding structure 20 may include a limiting protrusion located on the shaft axle of the hinge 22. As the upright plate 5 rotates about the shaft axle of the hinge 22, the hinge portion mounted on the upright plate 5 may come into contact the limiting protrusion in the circumferential direction of the shaft axle, thereby maintaining the upright plate 5 in a horizontal position.

In some aspects, if no holding structure 20 is provided, damping hinges can serve as the hinges 22. In the absence of external force applied to the upright plate 5, it remains stationary relative to the base plate 4 and cannot freely rotate. To transition the upright plate 5 from a vertical to a horizontal position, an external force is necessary to rotate it to a horizontal position. The damping hinges maintain the upright plate 5 in place.

In other embodiments, the upright plates of the expansion platform 12 can rotate relative to the base plate to align with it, thereby further expanding the supporting and placement space of the cart for photographing.

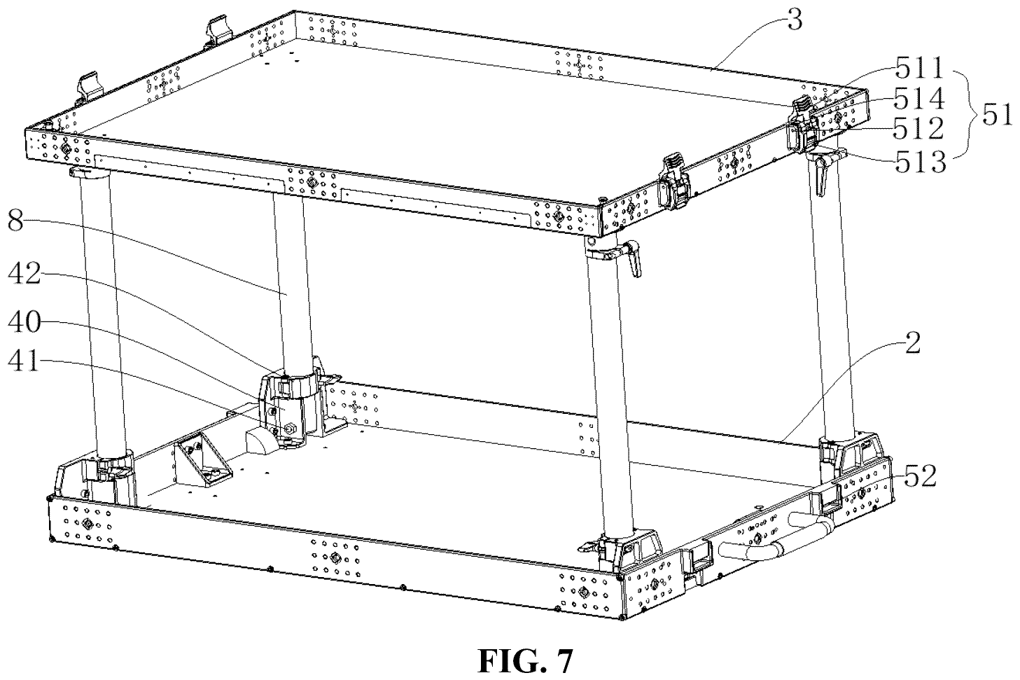

In some embodiments, the storage platform 1 includes a first storage platform 2 and a second storage platform 3 connected to the support pillars 81 at both ends. One end of each support pillar 81 is detachably connected to the second storage platform 3, while the other end is assembled within the storage slot 7 of the first storage platform 2 via a support pillar shaft 41 (FIG. 7).

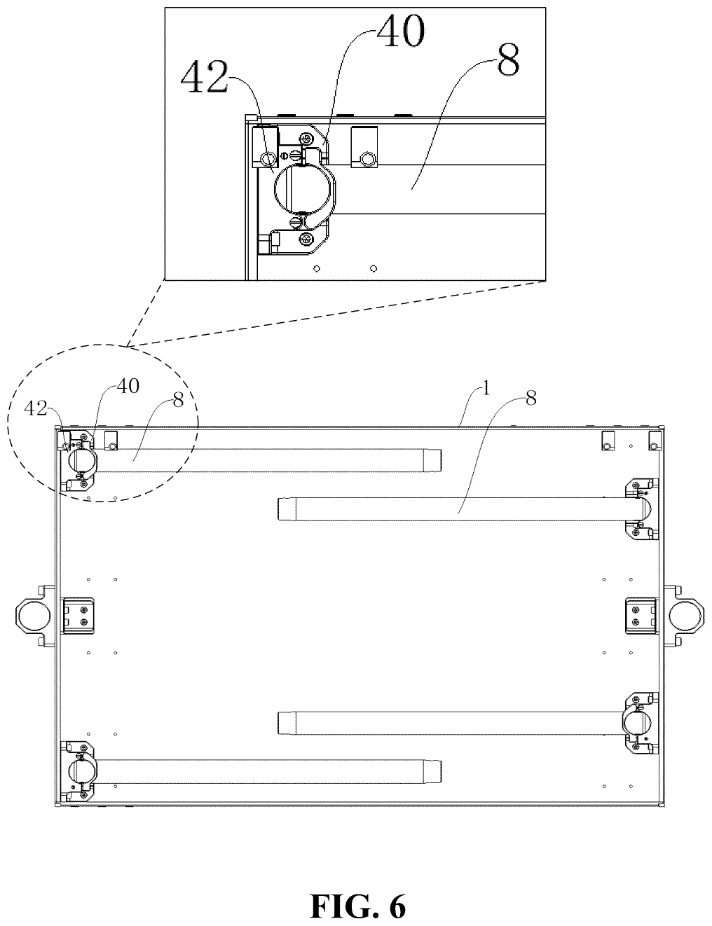

Referring to FIGS. 6 and 7, during operation, the first storage platform 2 is positioned beneath the second storage platform 3. The upper ends of the four support pillars 81 are detachably connected to the second storage platform 3 via pipe clamps mounted on the base plate 4 of the second storage platform 3. The lower ends of these support pillars 81 can be detachably installed in the storage slot 7 of the first storage platform 2. Mounting brackets 40 are situated inside the storage slot 7 of the first storage platform 2 at the connection points between the base plate 4 and the upright plate 5. The lower ends of the support pillars 81 are initially pivotally connected to the mounting brackets 40 via support pillar shafts 41, enabling rotation around these shafts. The support pillar shaft 41 may be a bolt. Positioned on the upper side of the mounting bracket 40 is an installation pipe clamp 42. When the support pillar 81 rotates to a vertical position, perpendicular to the base plate 4 of the first storage platform 2, it fits into the installation pipe clamp 42. By tightening the bolt of the installation pipe clamp 42, the support pillar 81 is secured to the first storage platform 2 via the mounting bracket 40.

Continuing with FIGS. 6 and 7, all four support pillars 81 can be detachably installed in the storage slot 7 of the first storage platform 2 via the mounting brackets 40, and each can rotate relative to the first storage platform 2. The four mounting brackets 40 are arranged in pairs at both ends of the base plate 4 in the length direction, with the two brackets at one end spaced apart in the width direction of the base plate 4. Staggered arrangement of the four mounting brackets 40 enables the support pillars 81 to be accommodated when rotated to a horizontal position, aligning with the staggered arrangement of the four support pillars 81 n the width direction of the base plate 4 after the support pillars 81 rotating into the storage slot 7 of the first storage platform 2.

In alternative embodiments, the support pillar shaft 41 between the end of the support pillar 81 and the mounting bracket 40 may be omitted. Instead, the end of the support pillar 81 can be fixedly attached to the base plate 4 via the installation pipe clamp 42 mounted on it. This allows the entire support pillar 81 to be detached from the cart for photographing and stored in the storage slot 7 of the first storage platform 2 for accommodating.

Alternatively, in some other embodiments, the end of the support pillar 81 connected to the mounting bracket 40 may only be linked to the mounting bracket 40 via the support pillar shaft 41. The support pillar 81 can only rotate relative to the base plate 4 towards the storage slot 7. No installation pipe clamp 42 is positioned on the mounting bracket 40. The upper end of the support pillar 81 is firmly attached to the base plate 4 of the second storage platform 3 via pipe clamps mounted on it.

In some embodiments, either the first storage platform 2 or the second storage platform 3 is equipped with a latch 51, while the other platform features a mounting slot 52 that cooperates with the latch 51.

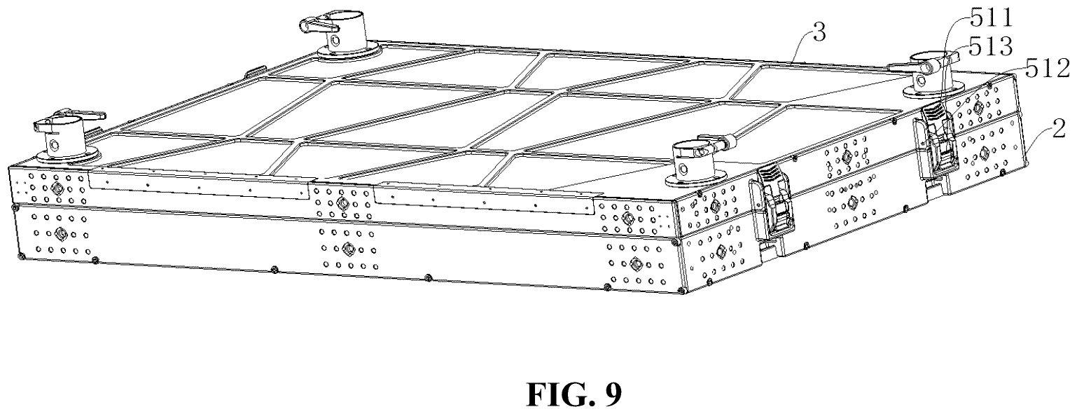

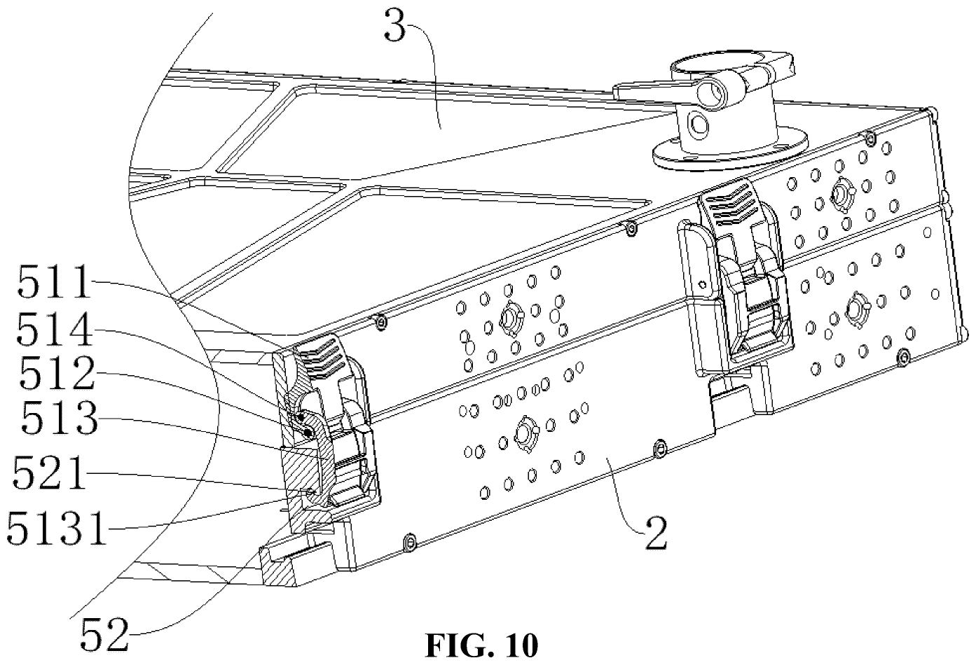

Specifically, referring to FIGS. 7 to 10. A latch 51 can be set on the upright plate 5 of the second storage platform 3, and a mounting slot 52 can be set on the upright plate 5 of the first storage platform 2. The latch 51 includes a lever part 511 and a hook part 513. The lever part 511 is rotatably mounted on the upright plate 5 of the second storage platform 3 via a lever shaft 512. The lever part 511 can rotate around the lever shaft 512 towards or away from the first storage platform 2. The hook part 513 is rotatably mounted on the lever part 511 via a hook shaft 514. The hook part 513 can rotate around the hook shaft 514 towards or away from the first storage platform 2. The lever shaft 512 is spaced apart from the hook shaft 514. One side wall of the mounting slot 52 is provided with a protrusion 521 facing away from the second storage platform 3. The hook part 513 has an inner recess 5131 recessed backwards the hook shaft 514. The inner recess 5131 can be adapted to engage with the protrusion 521 on the mounting slot 52.

After the support pillar 81 is stored in the storage slot 7 of the first storage platform 2, the hook part 513 rotates towards the first storage platform 2 until the hook part 513 is inside the mounting slot 52. Then, the lever part 511 is rotated away from the first storage platform 2. The inner recess 5131 of the hook part 513 can hook onto the protrusion 521 of the mounting slot 52 until it fits snugly against the protrusion 521. This achieves a fixed connection between the first storage platform 2 and the second storage platform 3. The first storage platform 2 and the second storage platform 3 can enclose to form a box, and the space between the first storage platform 2 and the second storage platform 3 is the internal storage space of the box, which can accommodate the support pillars 81 and photographic accessories.

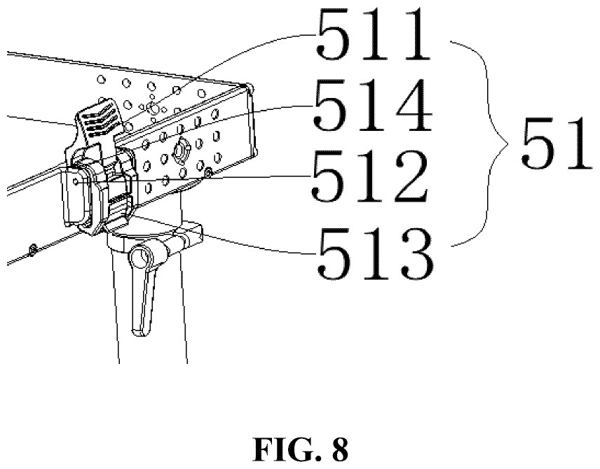

To increase the capacity of the internal storage space of the box, referring to FIGS. 8-10. The hooks 51 on the second storage platform 3 can be set so that their hook parts 513 face the slot openings of the storage slots 7 of the second storage platform 3. After the cart is stored as a box, the slot openings of the storage slots 7 of the first storage platform 2 face the second storage platform 3, and the slot openings of the storage slots 7 of the second storage platform 3 face the first storage platform 2. This increases the capacity of the internal storage space of the box to the sum of the capacities of the storage slots 7 of the first storage platform 2 and the second storage platform 3.

Of course, in some other embodiments, the hook parts 513 of the hooks 51 on the second storage platform 3 can also face the base plate 4 of the second storage platform 3. After the cart is stored as a box, the base plate 4 of the second storage platform 3 seals the slot openings of the storage slots 7 of the first storage platform 2. The capacity of the internal storage space of the box is the capacity of the storage slots 7 of the first storage platform 2.

The application of specific examples provided herein to illustrate the present disclosure is solely intended to facilitate comprehension and does not constitute a limitation. Technical personnel in the relevant field can make numerous straightforward deductions, modifications, or substitutions based on the fundamental concept of the present disclosure.

What is claimed is:

1. A cart for photographing, comprising:
a cart frame comprising a plurality of support members;
a storage platform connected to the support members, the storage platform comprising a base plate and an upright plate;
the upright plate comprising a plurality of upright plates, the plurality of upright plates arranged continuously around the base plate, enclosing a storage slot for supporting a photography accessory; and
the plurality of upright plate being equipped with a plurality of connection interfaces corresponding to various specifications for installing the photography accessory.

2. The cart for photographing according to claim 1, further comprising an expansion component,
the expansion component connected to at least one of the plurality of support members;
the expansion component comprising a plurality of expansion interfaces of different specifications for installing the photography accessory.

3. The cart for photographing according to claim 2,
wherein the connection interfaces comprise at least one of a threaded interface, a gear interface, a groove, a slider, or a duct interface; and
the plurality of expansion interfaces comprise one or more of a threaded interface, a gear interface, a groove, a slider, or a duct interface.

4. The cart for photographing according to claim 2, wherein the expansion component comprises an expansion connecting piece and an expansion platform;
the expansion platform being mounted on at least one of the plurality of support members by the expansion connecting piece, and
the expansion platform comprises an expansion slot for supporting the photography accessory.

5. The cart for photographing according to claim 4, wherein both the expansion connecting piece and the expansion platform are equipped with the expansion interfaces.

6. The cart for photographing according to claim 1, wherein the upright plate is pivotally connected to the base plate, and a locking structure secures the upright plate to the base plate;
the locking structure comprises a locking pin provided on one of the upright plate and the base plate and a locking hook or loop provided on the other one of the upright plate and the base plate;
the locking structure is operable in a locked state and an unlocked state;
in the locked state, the locking pin engages with the locking hook or loop, maintaining the upright plate perpendicular to the base plate; and
in the unlocked state, the locking pin disengages from the locking hook or loop, enabling the upright plates to rotate relative to the base plate.

7. The cart for photographing according to claim 6, wherein the upright plate is connected to the base plate via a damping hinge, and the damping hinge is capable of maintaining the upright plate at the same level as the base plate.

8. The cart for photographing according to claim 6, wherein the storage platform comprises a holding structure capable of maintaining the upright plate at the same level as the base plate.

9. The cart for photographing according to claim 8, wherein the holding structure comprises a tension rope connecting the base plate and the upright plate.

10. The cart for photographing according to claim 8, wherein the holding structure comprises a limit support member installed on the base plate, supporting the upright plate to keep the upright plate aligned with the base plate.

11. The cart for photographing according to claim 1, wherein each of the plurality of support members comprises a support pillar, and the storage platform comprises a first storage platform and a second storage platform connected to the support pillar at opposing ends; and
a first end of the support pillar is detachably connected to the second storage platform, and a second end of the support pillar is movably assembled within a storage slot of the first storage platform by a support pillar shaft that movably connects the support pillar to the first storage platform.

12. The cart for photographing according to claim 11, further comprising:
a latch being provided on one of the first storage platform or the second storage platform; and
a mounting slot, cooperating with the latch, being provided on the other one of the first storage platform and second storage platform.
